(19) United States
(12) Patent Application Publication
(10) Pub. No.: US 2012/0091228 A1
(43) Pub. Date: Apr. 19, 2012

(54) SPRAY DEVICE FOR GENERATING FOAM

(75) Inventor: Sen-Li TSENG, Taichung City (TW)

(73) Assignee: HSIH TUNG TOOLING CO.,LTD., Taichung City (TW)

(21) Appl. No.: 12/906,151

(22) Filed: Oct. 18, 2010

(51) Int. Cl. B05B 7/00

(52) U.S. Cl. 239/311

(57) ABSTRACT

A spray device for generating foam includes a container provided for receiving liquid, a spray element mounted on a top of the container, a guiding tube extending into an interior of container, and a pressurizing element mounted on the container. The spray element has a guiding channel defined therein. The guiding tube is connected with the guiding channel. The guiding tube has an air hole laterally defined therein and positioned adjacent to the guiding channel. The pressurizing element is manually operated to aerate air into the container to compress the air in the container for pushing the liquid spraying from spray element via the guiding tube.

### BACKGROUND OF THE INVENTION

1. Field of the Invention

The present invention relates to a spray device, and more particularly to a spray device for simultaneously supplying pressurized vapor and pressurized liquid.

2. Description of Related Art

A conventional spray device is actuated by electric power and connected to a pressurizing device. The spray device includes a container, a connecting unit mounted on the container, and a spray unit. The container includes a bucket. The bucket having a space defined therein and an opening end disposed on a top thereof for communicating with the space. A cap is gas-tightly sleeved on the opening end. The connecting unit has an unidirectional valve tube mounted on the opening end and extending into the bucket. The connecting unit has a connecting tube connected with the unidirectional valve tube and connected with the pressurizing device for aerating gas into the bucket. The spray unit has a spray valve tube mounted on the opening end, an exhausting tube extending from the spray valve tube and extending into the bucket, and a spray tube connected with the spray valve tube for outwardly spraying liquid. When the pressurizing device pumps and pressurizes gas into the container, the liquid is pressurized and outwardly sprayed from the spray tube.

Another conventional spray device is manually operated. The conventional spray device comprises a bucket, a pressurizing tube mounted on a top of the bucket, and a spray tube inserted into the bucket. When operating, the pressurizing tube is manually operated to aerating gas into the bucket. A pressure in the bucket is increased and presses liquid to be sprayed from the spray tube.

However, the conventional spray device only provides mist spray effect, and can not provide spumescence effect. The clean effort is not enough.

The present invention has arisen to obviate/mitigate the disadvantages of the conventional spray device.

### SUMMARY OF THE INVENTION

The main objective of the present invention is to provide an improved spray device for generating foam.

To achieve the objective, a spray device for generating foam in accordance with the present invention a container provided for receiving liquid, a spray element mounted on a top of the container, a guiding tube mounted in the container and extending into an interior of the container for exhausting liquid from the container, and a pressurizing element mounted on the container. The container has an outer threaded section formed on an outer periphery of the top thereof. The spray element includes a head, a diverting tube mounted on the head, and a nozzle tube sleeved on the diverting tube. The head has an inner threaded section formed on a bottom thereof for corresponding to the outer threaded section of the container. The head has a handle extending therefrom and downwardly bended. The diverting tube has a through hole radially defined therein. The through hole is positioned in the nozzle tube. The nozzle tube has a diffuser mounted therein and positioned in the guiding channel for disturbing the liquid to generate foam. The diffuser is presented in the form of a fabric, a paper, a net, or a material which has a plurality of apertures for generating foam. The spray element has a guiding channel formed in the diverting tube and the nozzle tube and extending into the head via the through hole. The guiding channel is provided for guiding the liquid outward. The spray element has a movable valve mounted on the head thereof for sealing/unsealing the guiding channel. The movable valve has a valve head mounted in the head for selectively sealing a part of the guiding channel positioned between the head and diverting tube. The movable valve has a spring mounted in the head and abutted against the valve head for keeping the guiding channel sealed. The movable valve has a knob pivotally mounted on the head and connected with the spring to selectively drive the valve head backward for unsealing the guiding channel. The guiding tube connected with the guiding channel, the guiding tube having an air hole laterally defined therein and positioned adjacent to the guiding channel. The air hole in the guiding tube has a diameter being 1.2 mm to attain a best effect for mixing air and the liquid. The pressurizing element is manually operated to aerate air into the container to compress the air in the container for pushing the liquid spraying from spray element via the guiding tube. The pressurizing element includes an inner tube mounted in the container and extending into the interior of the container and a pumping rod mounted in the container and partially received in the inner tube. The pumping rod is movable relative to the inner tube. The pumping rod has an upper flange radially formed on a bottom thereof and a lower flange radially formed on the bottom thereof adjacent to the upper flange. A pumping hole is defined in a lateral of the pumping rod and passing through the pumping rod. The pumping hole is positioned between the upper flange and the lower flange. An elastic ring is annularly sleeved on the pumping rod and movably positioned between the upper flange and the lower flange for engaging with an inner periphery of the inner tube. A plug is mounted in a bottom distal end of the pumping rod.

Further benefits and advantages of the present invention will become apparent after a careful reading of the detailed description with appropriate reference to the accompanying drawings.

### BRIEF DESCRIPTION OF THE DRAWINGS

FIG. 1 is a partial exploded perspective view of a spray device for generating foam in accordance with the present invention;

FIG. 2 is a partial assembled perspective view of the spray device for generating foam in accordance with the present invention in another direction;

FIG. 3 is an enlarged partial cross-sectional view of a pumping rod of the spray device;

FIG. 4 is an enlarged partial cross-sectional view of a diverting tube, a nozzle tube, and a diffuser of the spray device;

FIG. 5 is an assembled perspective view of the spray device for generating foam in accordance with the present invention;

FIG. 6 is a cross-sectional view of the spray device for generating foam in accordance with the present invention; and

FIGS. 7-9 are operational cross-sectional views of the spray device for generating foam in accordance with the present invention.

### DETAILED DESCRIPTION OF THE INVENTION

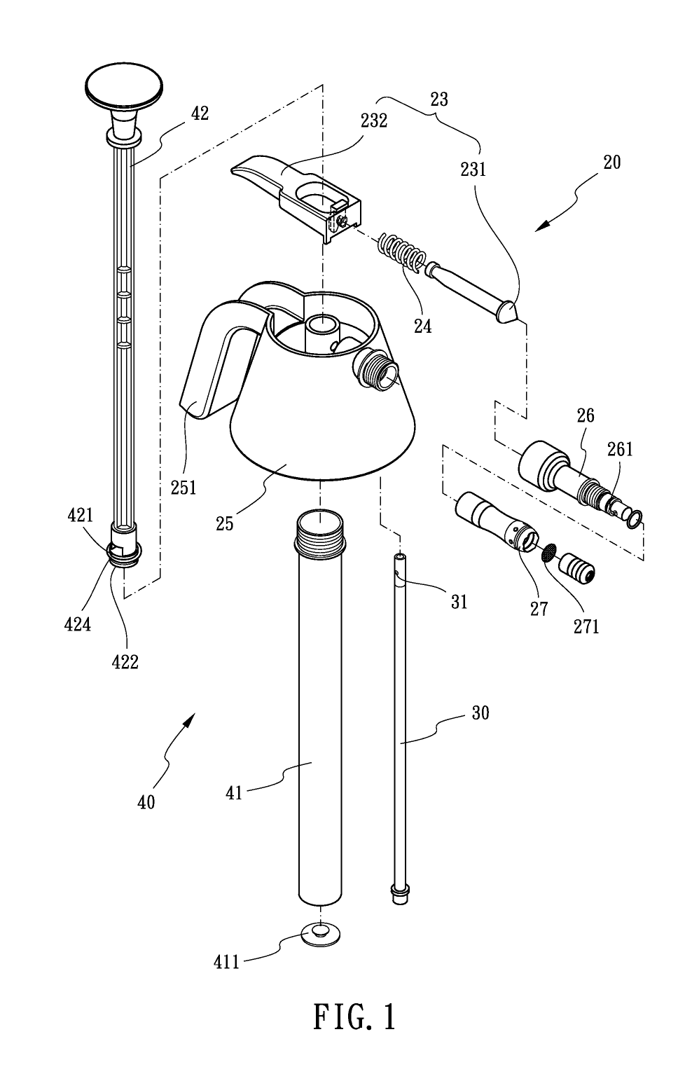

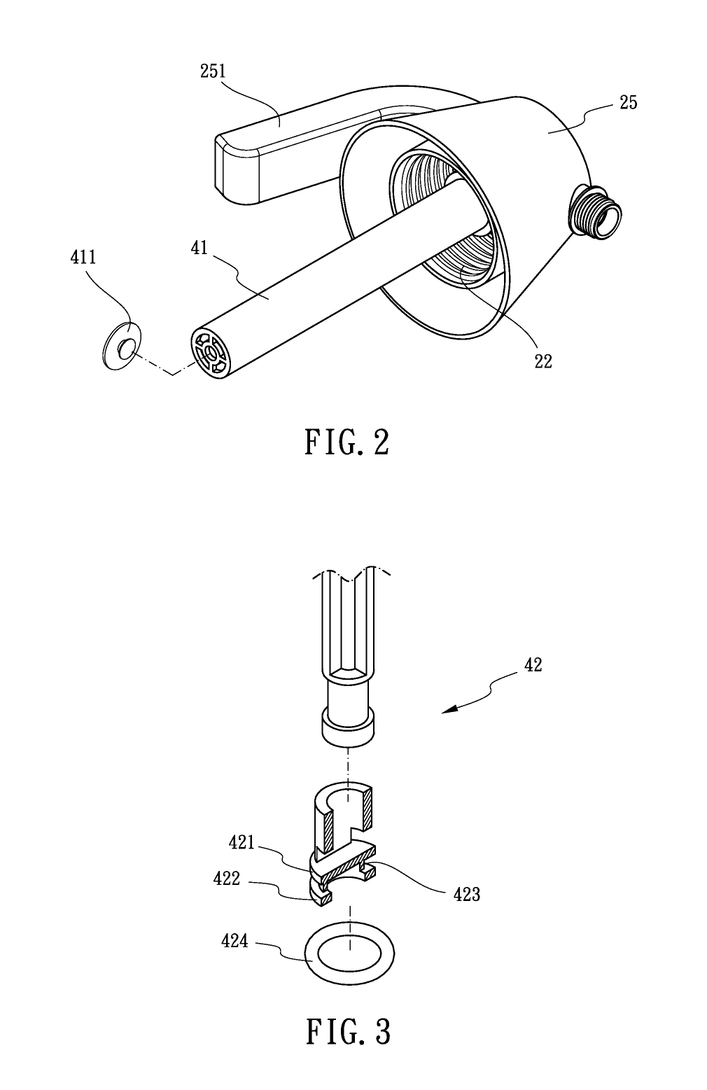

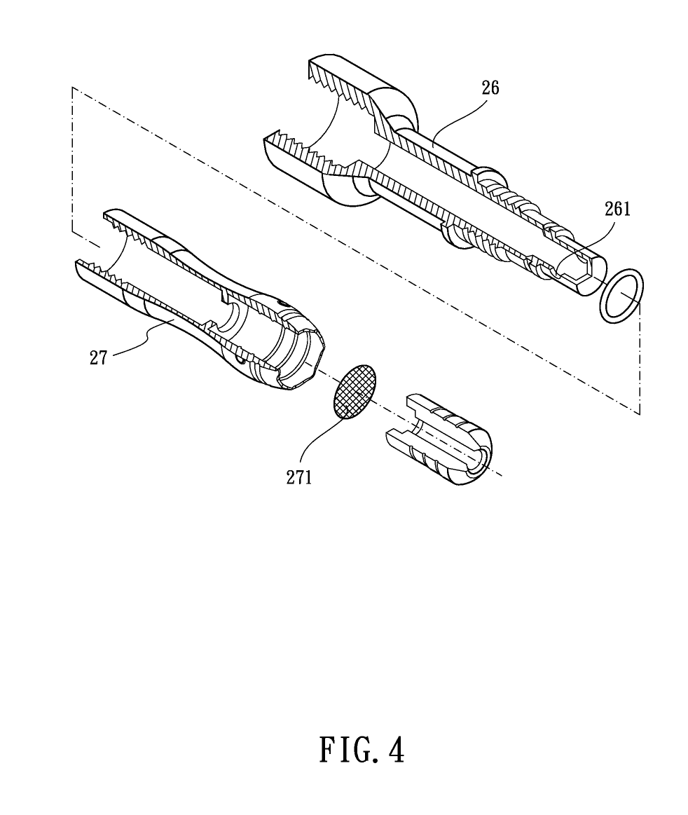

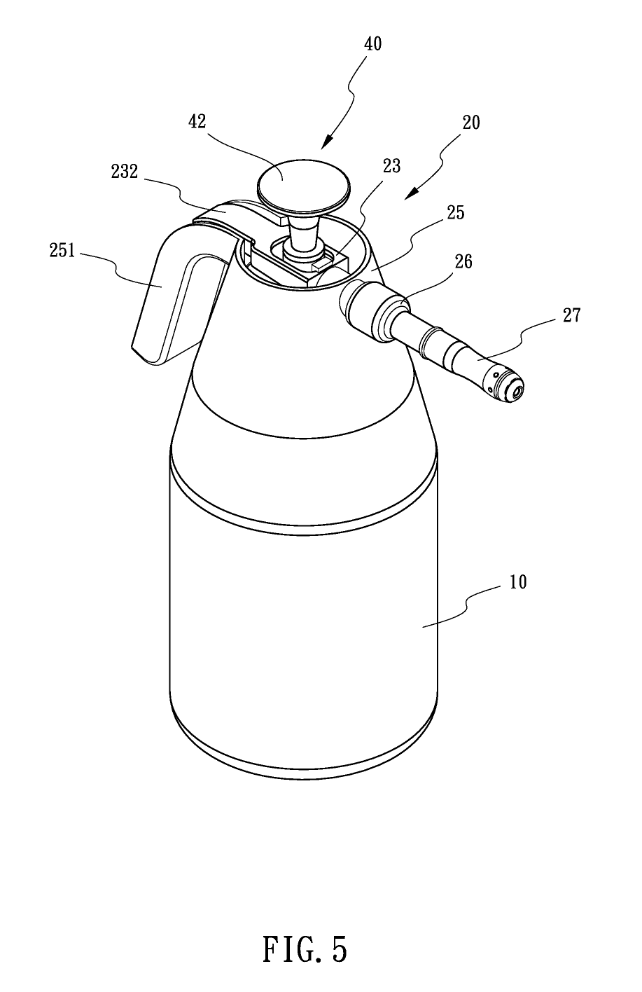

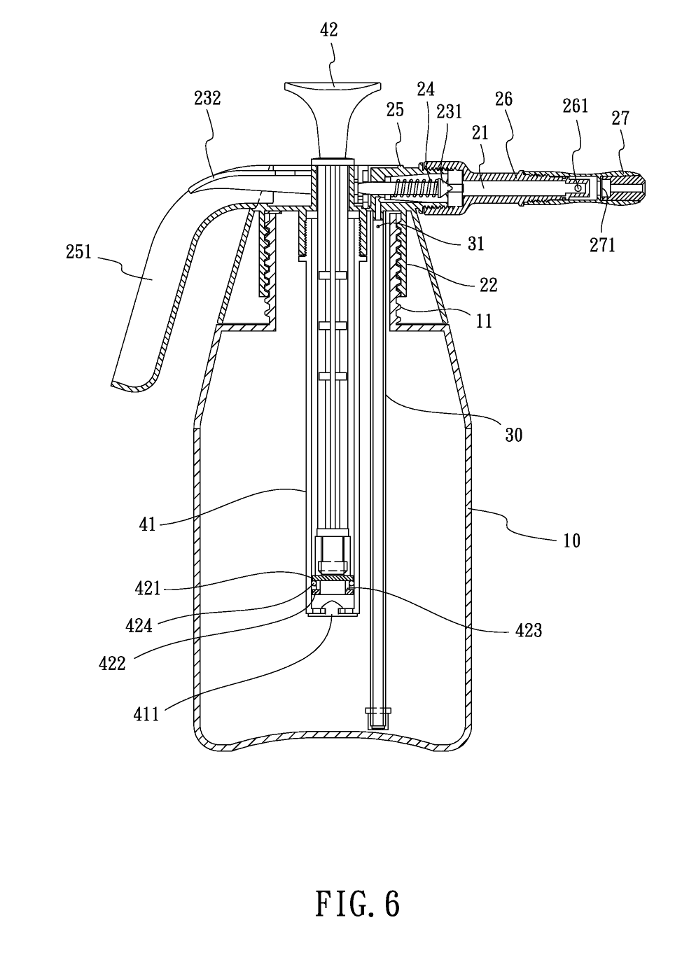

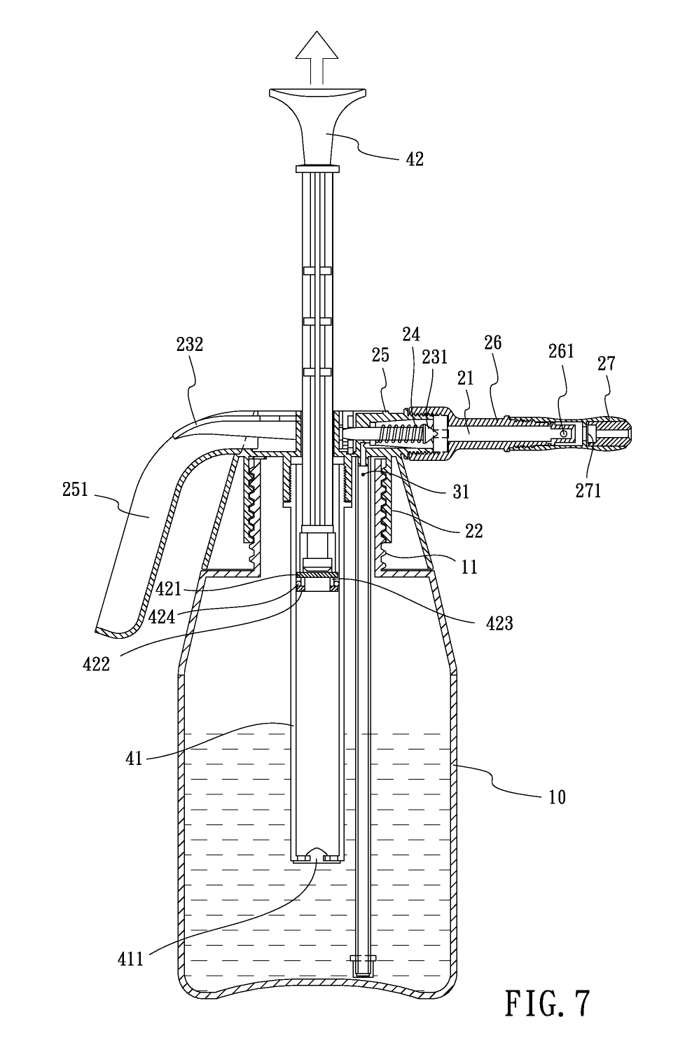

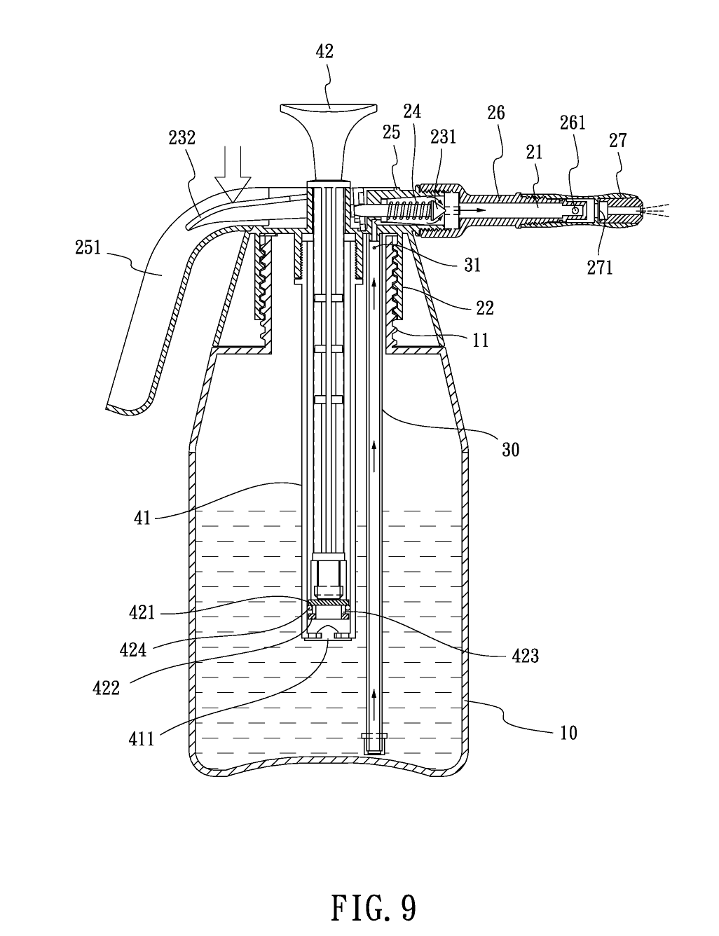

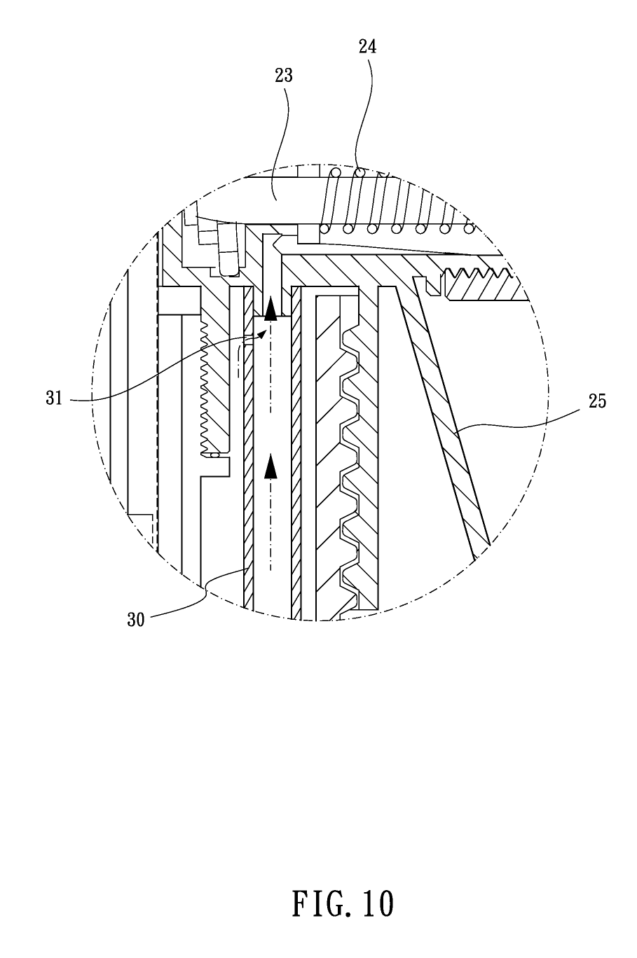

Referring to the drawings and initially to FIGS. 1-9, the spray device for generating foam in accordance with the present invention comprises a container 10, a spray element 20 mounted on a top of the container 10 provided for receiving liquid, a guiding tube 30 mounted in the container 10 and extending into an interior of the container 10 for exhausting liquid from the container 10, and a pressurizing element 40 mounted on the container 10.

The liquid can be cleaner, or any solvent provided for easily generating foam. The container 10 is presented in a form of plastic material which provides a highly compression-resist effect. The container 10 has an outer threaded section 11 formed on an outer periphery of the top thereof.

The spray element 20 is provided for controllably spraying the liquid. The spray element 20 includes a head 25, a diverting tube 26 mounted on the head 25, and a nozzle tube 27 sleeved on the diverting tube 26. The head 25 has an inner threaded section 22 formed on a bottom thereof for corresponding to the outer threaded section 11 of the container 10. The head 25 has a handle 251 extending therefrom and downwardly bended. The diverting tube 26 has a through hole 261 radially defined therein. The through hole 261 is positioned in the nozzle tube 27. The nozzle tube 27 has a diffuser 271 mounted therein and positioned in the guiding channel 21 for disturbing the liquid to generate foam. The diffuser 271 is presented in the form of a fabric, a paper, a net, or a material which has a plurality of apertures for generating foam. The spray element 20 has a guiding channel 21 formed in the diverting tube 26 and the nozzle tube 27 and extending into the head 25 via the through hole 261. The guiding channel 21 is provided for guiding the liquid outward. The spray element 20 has a movable valve 23 mounted on the head 25 thereof for sealing/unsealing the guiding channel 21. The movable valve 23 has a valve head 231 mounted in the head 25 for selectively sealing a part of the guiding channel 21 which is positioned between the head 25 and diverting tube 26. The movable valve 23 has a spring 24 mounted in the head 25 and abutted against the valve head 231 for keeping the guiding channel 21 sealed. The movable valve 23 has a knob 232 pivotally mounted on the head 25 and connected with the spring 24 to selectively drive the valve head 231 backward for unsealing the guiding channel 21.

The guiding tube 30 connected with the guiding channel 21, the guiding tube 30 having an air hole 31 laterally defined therein and positioned adjacent to the guiding channel 21. The air hole 31 in the guiding tube 30 has a diameter being 1.2 mm to provide a best effect for mixing air and the liquid.

The pressurizing element 40 is manually operated to aerate air into the container 10 to compress the air in the container 10 for pushing the liquid spraying from spray element 20 via the guiding tube 30. The pressurizing element 40 includes an inner tube 41 mounted in the container 10 and extending into the interior of the container 10 and a pumping rod 42 mounted in the container 10 and partially received in the inner tube 41. The pumping rod 42 is movable relative to the inner tube 41. The pumping rod 42 has an upper flange 421 radially formed on a bottom thereof and a lower flange 422 radially formed on the bottom thereof adjacent to the upper flange 421. A pumping hole 423 is defined in a lateral of the pumping rod 42 and passing through the pumping rod 42. The pumping hole 423 is positioned between the upper flange 421 and the lower flange 422. An elastic ring 424 is annularly sleeved on the pumping rod 42 and movably positioned between the upper flange 421 and the lower flange 422 for engaging with an inner periphery of the inner tube 41. A plug 411 is mounted in a bottom distal end of the pumping rod 42.

When the pressurizing element 40 manually aerates air into the container 10 and the liquid is sprayed from the spray element 20, the compressed air in the container 10 pushes the liquid from the guiding tube 30 to the spray element 20. The compressed air is aerated into the air hole 31 and mixed with the liquid flowing in the guiding tube 30 to generate foam.

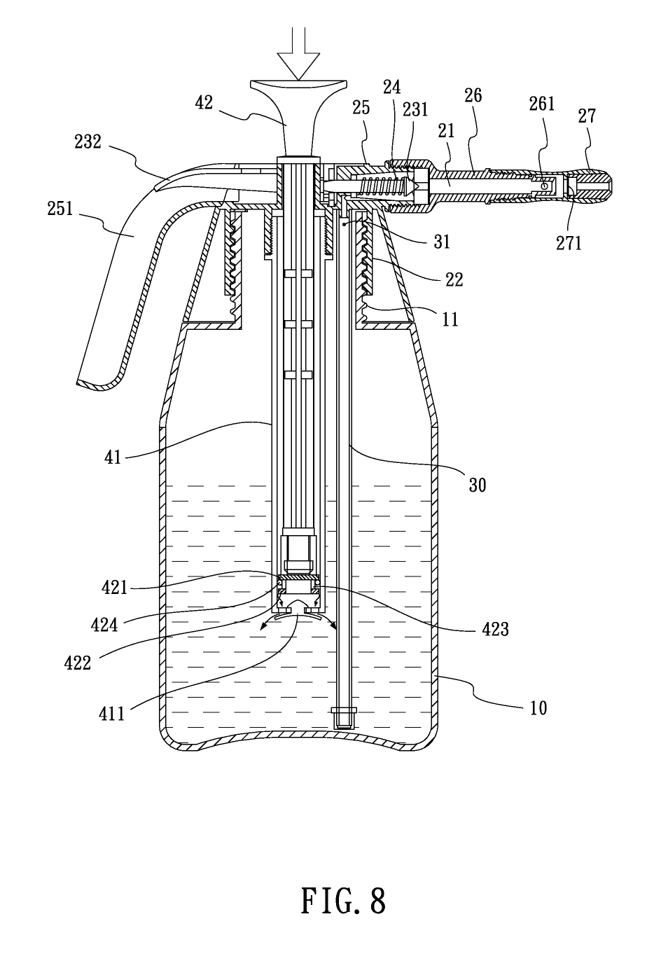

With reference to FIGS. 7-10, when the pumping rod 42 is upwardly pulled from the inner tube 41, the elastic ring 424 is downwardly moved toward the lower flange 422 such that the pumping hole 423 is exposed and the air outside of the container 10 which is able to be aerated into the inner tube 41. When the pumping rod 42 is pushed into the inner tube 41, the elastic ring 424 is upwardly moved toward the upper flange 421 such that the pumping hole 423 is blocked and the elastic flange is firmly engaged with the inner periphery of the inner tube 41. The air in the container 10 is hermetically sealed. The air in the inner tube 41 is pushed into the container 10 by the pumping rod 42. The plug 411 is partially detached from the inner tube 41 such that the air in the inner tube 41 is able to flow into the container 10. Therefore, the air in the container 10 is compressed. When an air pressure in the container 10 is accumulated to a predetermined value, the compressed air in the container 10 pushes the liquid to be sprayed.

As above described, the spray device in accordance with the present invention provides the compressed air mixed with the liquid to generate foam before spraying. When the liquid is replaced with the cleaner, the cleaner is able to be mixed with compressed air to generate stickiest foam for providing a best clean effect.

Although the invention has been explained in relations to its preferred embodiment, it is to be understood that many other possible modifications and variations can be made without departing from the spirit and scope of the invention as hereinafter claimed.

What is claimed is:

1. A spray device for generating foam comprising:
a container provided for receiving liquid;
a spray element mounted on a top of the container, the spray element provided for controllably spraying the liquid, the spray element having a guiding channel defined therein for guiding the liquid outward;
a guiding tube mounted in the container and extending into an interior of container for exhausting the liquid from the container, the guiding tube connected with the guiding channel, the guiding tube having an air hole laterally defined therein and positioned adjacent to the guiding channel; and
a pressurizing element mounted on the container, the pressurizing element manually operated to aerate air into the container to compress the air in the container for pushing the liquid spraying from spray element via the guiding tube;
wherein when the liquid is sprayed from the spray element, the compressed air is aerated into the air hole and mixed with the liquid flowing in the guiding tube to generate foam.

2. The spray device for generating foam as claimed in claim 1, wherein the spray element has a head, a diverting tube mounted on the head, and a nozzle tube sleeved on the diverting tube, the guiding channel formed in the diverting tube and the nozzle tube and extending into the head.

3. The spray device for generating foam as claimed in claim 2, wherein the container has an outer threaded section formed on an outer periphery of the top thereof, the head having an inner threaded section formed on a bottom thereof for corresponding to the outer threaded section of the container, the spray element having a movable valve mounted on the head thereof for sealing/unsealing the guiding channel, the movable valve including a valve head mounted in the head for selectively sealing a part of the guiding channel which is positioned between the head and diverting tube, a spring mounted in the head and abutted against the valve head for keeping the guiding channel sealed, and a knob pivotally mounted on the head and connected with the spring to selectively drive the valve head backward for unsealing the guiding channel.

4. The spray device for generating foam as claimed in claim 3, wherein the diverting tube has a through hole radially defined therein, the through hole positioned in the nozzle tube, the guiding channel extending from the head to the nozzle tube via the through hole, the nozzle tube having a diffuser mounted therein and positioned in the guiding channel for disturbing the liquid to generate foam.

5. The spray device for generating foam as claimed in claim 3, wherein the pressurizing element including an inner tube mounted in the container and extending into the interior of the container and a pumping rod mounted in the container and partially received in the inner tube, the pumping rod being movable relative to the inner tube, the pumping rod having an upper flange radially formed on a bottom thereof and a lower flange radially formed on the bottom thereof adjacent to the upper flange, a pumping hole defined in a lateral of the pumping rod and passing through the pumping rod, an elastic ring annularly sleeved on the pumping rod and movably positioned between the upper flange and the lower flange for engaging with an inner periphery of the inner tube, the pumping rod positioned between the upper flange and the lower flange, a plug mounted in a bottom distal end of the pumping rod.

6. The spray device for generating foam as claimed in claim 1, wherein the head has a handle extending therefrom and downwardly bended.

7. The spray device for generating foam as claimed in claim 1, wherein the air hole in the guiding tube has a diameter being 1.2 mm.

8. The spray device for generating foam as claimed in claim 1, wherein the diffuser is presented in the form of a fabric, a paper, a net, or a material which has a plurality of apertures.
